(19) United States
(12) Patent Application Publication
(10) Pub. No.: US 2022/0168733 A1
(43) Pub. Date: Jun. 2, 2022

(54) DEVICE AND METHOD FOR THE EXTRACTION OF NUCLEIC ACIDS

(71) Applicant: STRATEC SE, Birkenfeld (DE)

(72) Inventors: Meyer Andreas, Keltern (DE); Kirzinger Hannes, Purgen (DE)

(21) Appl. No.: 17/173,915

(22) Filed: Feb. 11, 2021

(30) Foreign Application Priority Data
Dec. 2, 2020 (EP) 20156954.8

(51) Int. Cl. B01L 3/00; B01L 3/02

(52) U.S. Cl. CPC B01L 3/502715; B01L 3/0275; B01L 3/5025; B01L 3/502707; B01L 3/502738; B01L 2300/1827; B01L 2200/0642; B01L 2300/021; B01L 2300/024; B01L 2300/042; B01L 2300/1822; B01L 3/502761

(57) ABSTRACT

A device and a method for the extraction of nucleic acids from samples comprising cells. The invention provides a consumable for handling liquids in automated analyser systems, comprising a plurality of cavities which are connected by a bridge, wherein the bridge defines a horizontal axis which connects the plurality of cavities, which are arranged in a straight line and wherein at least one cavity of the plurality of cavities is shaped to accommodate a pipette tip, and a handling interface, which is attached to the bridge. A device comprising the consumable and a method for using the consumable.

### CROSS-REFERENCE TO RELATED APPLICATIONS

The present application claims priority of European Application No. EP 20 156 954.8 filed on Feb. 12, 2020. The aforementioned application is hereby incorporated by reference in its entirety.

### BACKGROUND OF THE INVENTION

### Filed of the Invention

The invention relates to a device and a method for the extraction of nucleic acids from samples comprising cells.

### BRIEF DESCRIPTION OF THE RELATED ART

Automated analyzer systems for use in clinical diagnostics and life sciences are produced by several companies. For example, STRATEC® SE, Birkenfeld, Germany, produces a number of devices for specimen handling and analysis of samples, including diagnostic applications, for use in automated analyser systems and other laboratory instrumentation.

Nucleic acid extraction (NAE) methods relate to the extraction of both DNA (deoxyribonucleic acid) and RNA (ribonucleic acid) from samples but can be more broadly separated into chemical and mechanical methods. The following descriptions will focus on mechanical solid-phase methods and furthermore address processes which are based on magnetic particles or beads.

The magnetic beads technology represents a well-established strategy for the extraction of RNA and genomic, plasmid and mitochondrial DNA. Suitable buffer systems (mainly silica matrices) will be coupled via coating procedures to functionalized magnetic particles or beads. The extraction technique involves the separation of nucleic acids from complex mixtures and provides several advantages compared to other isolation processes:
Binding of target NA to the coating surface of the magnetic particles
Magnetic core facilitates manipulation and handling of the nucleic acid bead complexes.

In general, all semi-automated and fully automated NA extraction systems/instruments perform the following basic process steps of:
Lysis: Disruption/break open of cells to release NA;
NA Separation: Separation of NA from other cell components;
   Binding: Binding of NA to magnetic particle surface; and
   Washing: Removal of cellular material (debris) in multiple wash steps; and
NA isolation/extraction: Elution of NA.

Considering these basic steps in combination with the magnetic particle/bead approach all system-specific NA isolations come down to the four steps of lysis, binding, washing and elution. The modules or stand-alone instruments mainly differ in the actual implementation of the basic process steps.

A traditional extraction protocol, which employs magnetic beads (MBs) to isolate nucleic acids from whole blood in a disposable tube or vessel comprises the following steps:
a. Extraction steps processing NA extraction with reagents, sample, MBs and buffers in a tube, comprising:
   i. Mixing whole blood with enzyme and lysis buffer,
   ii. Adding magnetic beads and binding buffer to adsorb the NA,
   iii. Immobilizing beads and removing the suspension,
   iv. Adding a first wash buffer,
   v. Immobilizing beads and removing the suspension,
   vi. Adding a second, different wash buffer,
   vii. Immobilizing beads and removing the suspension, and
   viii. Eluting NA from the magnetic beads.
b. The interactions among MB, NA, particles and cell debris in the solution during extraction procedure, basically comprises the steps of:
   i. Cell lysis;
   ii. NA adsorption onto MBs;
   iii. Removing contaminants, particles and cell debris; and
   iv. Eluting NA from MBs.

U.S. Pat. No. 8,454,825 teaches a rod assembly for the extraction of magnetizable particles from solutions. The rod assembly includes at least one guide element. A rod element that is insertable into the at least one guide element and moveable in a direction substantially parallel to the at least one guide element. A magnet element is moveable to a distal magnet element position; wherein the distal magnet element position is located on a distal end section of the at least one guide element; wherein the at least one guide element includes an opening at a distal end. A method for the extraction of magnetizable particles from solutions is also described, as well as a magnet element for the extraction of magnetizable particles from solutions.

Other systems known from the prior art transfer the liquids between reaction wells via disposable tips and separate the magnetic beads (w/o bound NA) inside the cavities. The processing principle includes the following steps:
a. Introducing the sample to the instrument;
b. Sample lysis, inactivation of nucleases, and nucleic acids release;
c. Magnetic particle addition, binding of nucleic acids to particles;
d. Magnetic separation of nucleic acid particles-complex inside the reaction wells;
e. Multiple washing steps; and
f. Elution of purified nucleic acids from particles.

Another alternative is to transfer the liquids between reaction wells via disposable tips, wherein the magnetic particles (w/o bound NA) are separated inside the tip. The processing principle includes of the following steps: 1. Introduce sample to the instrument. 2. Cell disruption and protein digestion by addition of lysis buffer and enzyme. 3. NA binding to the surface of magnetic particles. 4. Magnetic separation of the nucleic acid-bead complex. 5. Removal of cellular debris by extensive washing steps. 6. Magnetic separation of the nucleic acid-bead complex. 7. NA elution at high temperatures during the removal of the magnetic particles.

There is also a system known, which performs the extraction in a single reaction cavity. The magnetic particles will be manipulated (separation and resuspension) via multiple movable magnetic arrays. Injectors dispense reagents and by the use of disposable aspirator tips the supernatant from each well can be removed. The processing principle includes the following steps: 1. During incubation of the lysed samples, all target nucleic acids are captured by magnetic particles. 2. The magnetic device attracts all magnetic beads, enabling the system to purify nucleic acids through several washing steps. 3. The heating step releases the NA form the beads. 4. At the final step, magnetic particles are separated from the eluate by the magnetic device.

All systems known from the prior art are related to a limited flexibility with respect to liquid components and assay extraction parameters.

### SUMMARY OF THE INVENTION

It is therefore the object of this invention to provide a device and a method for the extraction of nucleic acids from a cell sample with a high degree of flexibility regarding the used liquids and assay parameters.

The present invention provides a consumable for handling liquids in automated analyser systems, comprising:
a plurality of cavities which are connected by a bridge, wherein the bridge defines a horizontal axis which connects the plurality of cavities, which are arranged in a straight line and wherein at least one cavity of the plurality of cavities is shaped to accommodate a pipette tip; and
a handling interface, which is attached to the bridge.

In a further aspect of the present invention, the bridge can have a concave shape between two neighbouring cavities of the plurality of cavities to collect spilled liquids.

In another embodiment, the bridge can be arranged next to the openings of the plurality of cavities.

It is further intended for a consumable of the present invention, that each of the plurality of cavities may have a different diameter and/or depth and/or shape.

Another object of the present invention relates to a device for processing samples in an automated analyser system, comprising:
a loading section for:
   i. consumables as described above;
   ii. liquids necessary for sample processing; and
   iii. pipette tips adjusted to at least one cavity of the consumable's plurality of cavities for storing pipette tips;
a handling device for moving the consumables by interacting with the handling interface of the consumable;
a dispense robot for injecting liquids stored in the device into respective cavities of the plurality of cavities of the consumable; and
a control unit for storing information and protocols for different processing assays wherein the control unit is connected to a drive of the handling device and a drive of the dispense robot.

In a further aspect of the present invention, the device may comprise sections for different processing steps which are each stored in the control unit for performing them,

Another embodiment of the device may further encompass a further section which is configured to accommodate a plurality of consumables which can be processed simultaneously.

It is also intended that the device of the present invention may further comprise means for transporting the consumables between different sections.

It is also envisaged that a device of the present invention may comprise means for transporting of the consumable comprising a sledge with a corresponding drive system.

In a further embodiment of the present invention, the sledge may comprise cavities for heating and/or cooling of liquids in a cavity of the plurality of cavities in a consumable and/or magnets for separating magnetic beads comprised in a liquid in a cavity of the plurality of cavities in a consumable.

It is also intended that a device of the present invention may comprise a section for nucleic acid isolation and/or for performing Polymerase Chain Reactions.

The dispense robot of a device according to the present invention may further comprise a plurality of dispense units.

The present invention relates further to a method for extraction of a target compound from a liquid, comprising the steps of:
placing a consumable with a handling device through interaction with the handling interface of the consumable as described above into a transport sledge;
moving the consumables in the transport sledge to a dispense position;
sequential injection of bulk fluids into reaction vessels of the consumable according to a pre-defined injection protocol;
sequential addition of reagents and a sample into pre-defined vessels of the consumable;
applying a pipette tip into the storage cavity of the consumable;
moving the consumable below a wash lift for picking up pipette tip;
heating liquids in lysis and elution cavities of the consumable at pre-defined temperatures according to a pre-selected protocol;
aspirating and dispensing heated liquids for mixing them;
aspirating liquid and dispensing it into a target cavity of the consumable, adding magnetic beads;
magnetic bead separation by moving a separation magnet to the outer wall of the target cavity;
aspirating supernatant with an aspiration probe;
moving the consumable with the transport sledge to the below the wash lift;
pipetting dispensing and aspirating wash buffer into the target cavity for washing the fixed magnet beads which are released after dispensing wash buffer and fixed prior to aspirating wash buffer by moving the separation magnet from and to the outer wall of the target cavity; and
adding an elution buffer to the target cavity and collecting the supernatant comprising the target compound.

In a further aspect of the present invention, the target compound can be a nucleic acid, peptide or protein.

The method of the present invention may further comprise a step wherein the separation magnets can be moved along the outer wall of the target cavity.

It is further possible that the predefined protocol comprises the step of cooling of the liquids.

Another object of the present invention is the use of a method as described above for the extraction of nucleic acids in a first section of a device as described above and for performing Polymerase Chain Reactions in a neighbouring section of said device.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF SUMMARY OF THE FIGURES

The invention will be described based on figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention, in which:

FIG. 1 shows a multi-cavity reaction consumable.

FIG. 2A shows coupling of consumable and handling robot.

FIG. 2B shows disposable tip placing via pipettor.

FIG. 2C shows disposable filter tip placed in tip stand cavity.

FIG. 3 shows an instrument for nucleic acid extraction (NAE) on its right side and polymerase chain reaction (PCR) to be performed on its left side.

FIG. 4 shows a top view on the side of the instrument used for nucleic extraction with exemplary deck layout (pipettor not shown).

FIG. 5 shows the extraction module having four isolation bays and a common dispense sledge/robot.

FIG. 6A shows the 3D model of the extraction device with four isolation bays and a common dispense sledge.

FIG. 6B shows schematic cross section of main components.

FIGS. 7A-7C show an embodiment of a extraction consumable with three cavities: (FIG. 7A) Extraction consumable having a storage/parking handle and further a reaction cavity, an elution cavity and a disposable tip stand and intermediate waste cavity with a disposable filter tip in a perspective view, (FIG. 7B) cross section of former described extraction consumable and (FIG. 7C) extraction consumable with disposable filter tip in each of the three cavities.

FIG. 8 shows an exemplary design of a consumable transport/sledge with integrated tip stand cavities.

FIGS. 9A and 9B show stackable extraction consumable without tip stand: (FIG. 9A) Stackable consumable with handling interface and waste cavity instead of tip stand and (FIG. 9B) stack of consumables.

FIGS. 10A and 10B show stackable extraction consumable with fixed tip stand and flexible attached cavity: (FIG. 10A) Cross section of consumable concept/variant and (FIG. 10B) stack of consumables.

FIGS. 11A and 11B show stackable extraction consumable with fixed cavity and flexible attached tip stand: (FIG. 11A) Isometric view of consumable concept/variant and (FIG. 11B) stack of consumables.

FIG. 12 shows multi-cavity consumable with integrated drain feature above waste channel/funnel.

FIGS. 13A, 13B and 13C show an embodiment of a consumable with a common drip pan cavity: (FIG. 13A) Top view; (FIG. 13B) perspective view and (FIG. 13C) side view.

FIGS. 14A, 14B and 14C show embodiments of consumables with six cavities (FIG. 14A) and eight cavities (FIGS. 14B and 14C).

### DETAILED DESCRIPTION OF THE INVENTION

The technical problem is solved by the independent claims. The dependent claims cover further specific embodiments of the invention.

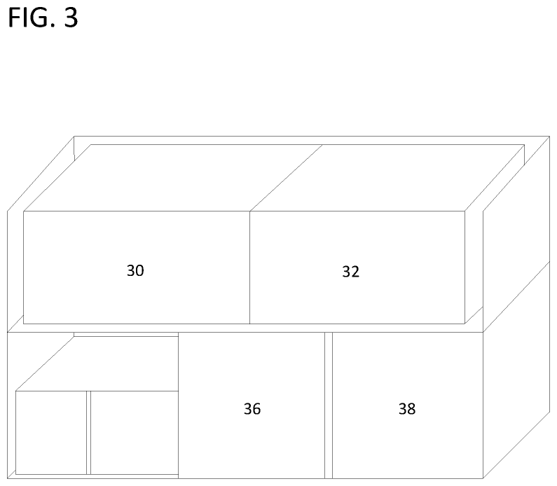

The invention refers to a part of a fully automated analysis system in the field of molecular diagnostics, which can perform nucleic acid extraction (NAE) as well as polymerase chain reaction (PCR) with a complete sample to result workflow (instrument shown in FIG. 3). The invention encompasses the complete NAE process and comprises of a system-specific consumable, device and a corresponding method using the consumable and device.

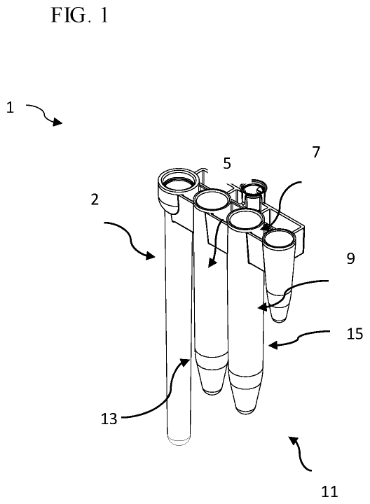

The consumable 1 according to the present invention, which is used for nucleic acid extraction, is a multi-cavity reaction disposable and provides different vessels for lysis 5, washing 9, elution 11 as well as the intermediate storage/holding of liquid waste and disposable tips 2 (FIG. 1).

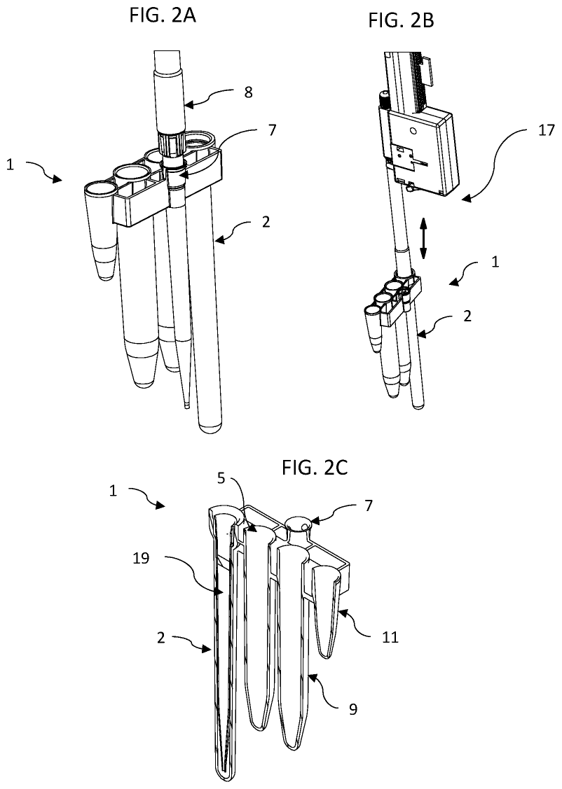

An integrated interface 7, 8 allows the automated handling and transport of the consumable 1 by a handling device like an internal robotic device (gripper) of the instrument (FIG. 2A) for example. Sizes and shapes of the cavities are tailored to the requirements and needs of the individual process steps (e.g., liquid volumes, interfacing vessel heating etc.). The bridge feature 13 near the vessel openings, which connects the different cavities, represents the Z-reference and allows reliable parking and storage of the consumable during the extraction process.

All cavities are arranged in a single line in order to reduce the required processing/handling effort. Small drip pans/chambers 15 between the reaction-wells collect dropped and spilled liquids for avoiding the unintentional spread of the fluids. To prevent potential contamination of the gripper, the handling/gripping interface 7 is located on one side besides the cavity array.

One receptacle serves as a tip stand 2 for holding and a possibly required intermediate storage/parking of disposable tips 19. The consumable will be equipped during extraction with a tip by a handling device like a pipetting robot 17 (FIG. 2B), which is required for sample handling and contamination-free processing.

The embodiment of an extraction module, which is described below for illustrating the invention, uses this tip for different liquid handling steps. After finishing nucleic acid isolation, disposable tips 19 can be stored back to the tip stand 2 for final disposal (FIG. 2C). As an alternative, the consumable can be delivered pre-equipped with disposable tips 19. After picking up the disposable tips 19 by the extraction member 34, the according tip stand 2 will be used as an intermediate waste cavity.

As already mentioned, an embodiment of an instrument for NAE and PCR is illustrated in FIG. 3. The instrument has a pipettor, PCR side 30, extraction side 32 and below a pipettor liquid/solid waste 36 and a bulk fluid supply 38.

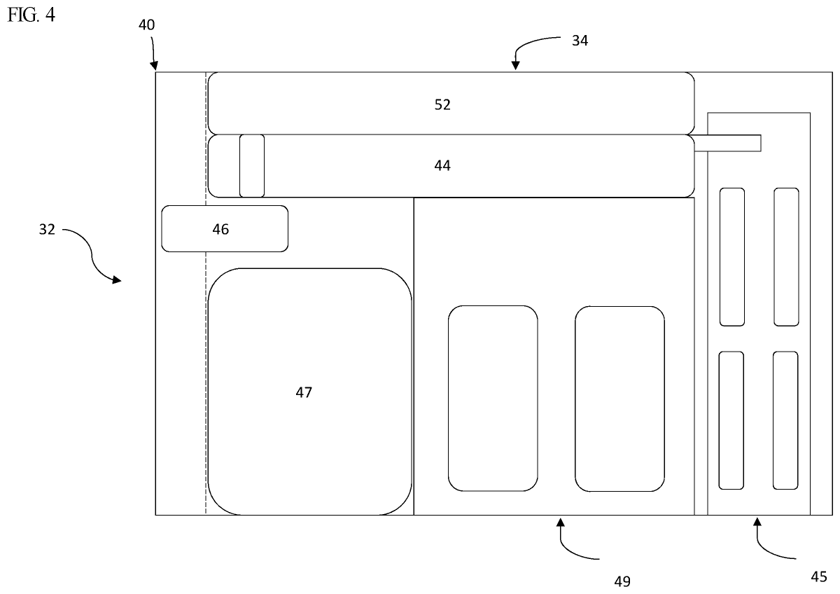

FIG. 4 shows the “Extraction Side” 32 of the molecular analyzer with an exemplary deck layout. The three user accessible loading members at the front ensure the supply of the system with primary samples 47, extraction consumables 49, disposable tips 45 and diverse reagents and controls, which are essential for nucleic acid isolation. Other required reagents, so called bulk fluids (including lysis, wash and elution buffers), will be supplied by another member, which is located in the instrument compartment (for example below the analyzer deck) together with relating dispense and metering pumps. A robot, for instance a three-axis portal robot, above the deck modules can be responsible for different pipetting and consumable handling steps. The actual NAE is processed by the according extraction member 34 in the back of the system.

The mentioned module consists of four discrete and full-featured isolation bays which are able to perform all required process steps from lysis to elution excluding the addition of liquids. In the shown configuration all isolation bays share one dispense robot (called dispense sledge) 44, which is an integral part of the extraction module 34. In combination with the former mentioned liquid supply system the dispense sledge 44 is responsible for the injection of bulk fluids where the tip-based pipetting robot adds special/sensitive reagents and sample.

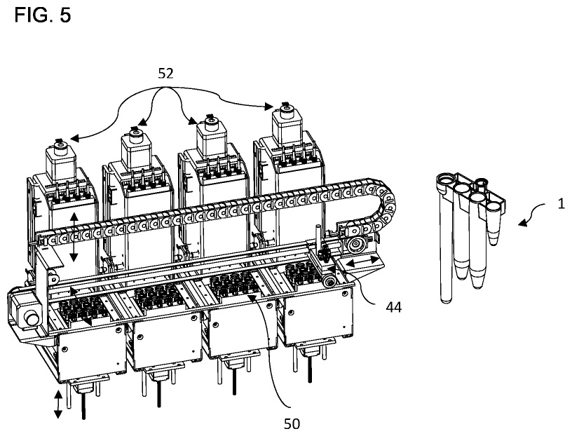

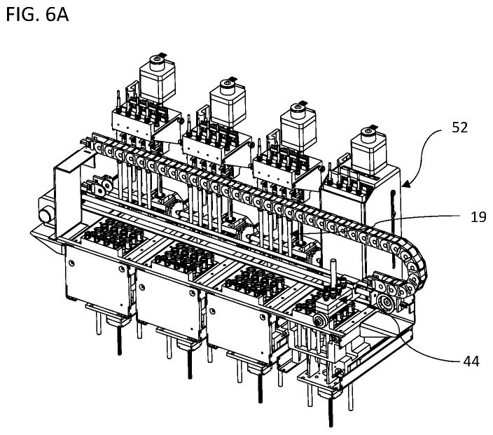

The isolation bays are designed as batch systems for the simultaneous processing of up to four samples and consumables, respectively. The batch sizes can be adapted according to the technical and commercial requirements/needs of the instrument. All these devices are equipped with the same functionalities (hardware). As a result of that the partial redundant extraction system provides a high flexibility regarding the detailed planning and execution of assay workflows (e.g., repetition of single steps, individual process times/durations etc.) up to the processing of different extraction protocols at the same time. The according module is shown in FIG. 5 and FIG. 6.

Each isolation bay is mainly composed of a consumable transport 50, a wash lift/tower 52 and an air pump-based pipetting module. The transport device moves the consumables between the different working positions (e.g., consumable loading and unloading, disposable tip pick-up and set down etc.). It includes a sledge 50 with corresponding drive system, integrated cavity heating 54 for lysis and elution as well as the magnetic particle separation devices 56 (e.g., permanent magnets). Every sledge 50 can also provide optional tip stand interfaces for the handover of tips to the extraction module by the pipetting robot and vice versa (if necessary).

The wash lift 52 (automated Z-axis) and the air pump pipetting module carry out essential liquid handling steps of the extraction. All these processes are tip-based and will be listed below:
Liquid transfer between cavities;
Mixing of liquid components; and
Resuspension of separated/collected magnetic particles.

According to this principle, each lift is able to pick up multiple disposable tips 19 (up to four) at the same time from the extraction consumables 1 or from the transport sledge directly. For that, the lift sledges provide dedicated tip interfaces. The NA isolation of subsequent/other samples requires that all devices can place the contaminated tips back to the corresponding extraction consumable 1 or the optional positions of the transport sledge. In addition, every lift assembly is equipped with four aspiration probes 60 for the discarding of liquid waste (e.g., supernatant or used reagents). The individual probes are connected via flexible tubing with a pump system to transfer the liquid waste to the relating reservoirs/containers.

The dispense robot (sledge) 44, which is operating above the consumable insertion positions of the extraction part 34, injects diverse bulk fluids into the individual reaction vessels according to the assay workflow. The robot is able to reach all consumable locations for the sequential and demand-based reagent dispense. Every sledge will be supplied by a fluidic/pump system that transfers the liquids from the storage container(s)/reservoir(s) to the individual injection ports. The robotic device can be equipped with two or more dispense units to generate also a redundant subsystem.

After completion of the final elution step (addition of elution buffer) the transport sledge of each isolation bay moves the extraction consumable(s) 1 containing the processed sample(s) to the according insertion and remove position. The handling robot will pick up the consumables 1 and transport them to a so-called eluate shuttle 46 (FIG. 4). This shuttle 46 mechanism is the only connection port between the strictly separated instrument areas 40 and transfers the disposables/eluates from the “Extraction Side” to the “PCR Side” for further processing (preparation of reaction sample and amplification). The separation of the instrument 40 should prevent the mutual influence of the different working areas by contamination.

The principal operation method and the available system functionalities, which were outlined above, will be explained in detail based on an exemplary extraction process step description in table 1. All assay parameters, for example, processing orders, volumes, temperatures, repetition numbers, durations etc. are adaptable, but the functional principle remains unchanged.

TABLE 1

| Process step | Step description |
|---|---|
| Extraction | Place consumable in transport sledge via |
| consumable | external handling robot (not part of extraction |
| insertion | module) and vertical downwards movement. An |
| | automated strip off / peel off mechanism enables |
| | the release of the consumable. |
| Extraction | Transport sledge moves consumables/ |
| consumable | individual reaction cavities between different |
| transfer | working positions for interaction with |
| | subsystems of extraction module (e.g., DiTi |
| | (disposable tip) pick up by wash lift) or |
| | peripheral / other modules of the instrument |
| | (e.g., consumable insertion by handling robot). |
| Reagent | Process step requires positioning of extraction |
| dispense / | consumable at dispense location (equal to |
| injection | consumable insertion / removal spot). Dispense |
| | sledge / unit will be moved above the extraction |
| | consumable, which should be processed. In |
| | general, sequential and demand-based injection |
| | of bulk fluids into diverse reaction vessels. |
| | Multiple injection ports according to the number |
| | of required buffers. |
| Reagent and | Sequential addition of reagents (e.g., enzyme, |
| sample | carrier RNA, internal control etc.) and sample |
| pipetting | via portal robot and tip-based pipettor. Pipetting |
| | also requires location of extraction consumable |
| | at insertion / removal position. |
| | Multi-pipetting of reagents feasible (one reagent |
| | loading / aspiration procedure at reagent |
| | reservoir followed by multiple dispense steps at |
| | different locations). Potential re-use of tips for |
| | reagent addition depends on acceptable reagent |
| | carry-over (liquid characteristics and mutual |
| | influence). To avoid cross-contamination every |
| | sample needs to be handled via a new DiTi. |
| DiTi placing | Pipettor places disposable tip in extraction |
| (by pipettor) | consumable located at insertion / removal |
| | position. Handover of tips to consumable (or |
| | optional to defined interface of transport sledge). |
| | Process step not needed, if extraction |
| | consumable is pre-equipped with DiTi. |
| DiTi pick up | Transport sledge drives DiTi within tip stand |
| (by wash lift) | cavity of the consumable below according to |
| | interface of the wash lift. Lift performs |
| | downwards movement for tip pick up. Option: |
| | Pick up of DiTi from “clean” sledge position. |
| Liquid heating | Heat and hold liquid volumes within lysis and |
| (for lysis and | elution cavities of the extraction consumable at |
| elution steps) | defined temperatures. Cavity heaters are |
| | integrated parts of the transport sledge. Separate |
| | heating elements allow individual temperature |
| Liquid mixing | control. |
| and | Multiple / repeated aspiration and dispense of |
| magnetic | liquids in order to mix components or resuspend |
| bead | magnetically separated particles / beads (“tip |
| resuspension | mixing”). Liquid handling via DiTi and air |
| | pump-based pipetting system within a reaction |
| | vessel. Resuspension requires release of |
| | magnetic particles (see also process step |
| | “magnetic bead separation / binding”). |
| Liquid | Assay-specific incubation of liquids for a |
| incubation | defined time period. No interaction between |
| | consumable and wash lift. Depending on the |
| | process step, simultaneous heating of defined |
| | cavities can be applied. |
| Liquid transfer | DiTi (on wash lift) enters step-specific reaction |
| | vessel for aspiration of complete liquid volume. |
| | Upward movement of lift and transfer of |
| | consumable target cavity below “active” tip. |
| | Downward movement into target cavity with |
| | liquid containing DiTi and subsequent dispense. |
| | Depending on process step transfer of liquids |
| Magnetic | with or without magnetic particles. |
| beads | Defined liquid handling steps require the |
| separation / | separation of the magnetic particles / beads and |
| “binding” | the surrounding liquid(s). During these process |
| (to cavity wall) | steps, a partial or the complete volume inside a |
| Note: | cavity must be aspirated without losing the |
| Differentiation | particles. A corresponding procedure is |
| to binding | necessary, for example, if liquids have to be |
| process of | exchanged or discarded. For the particle |
| nucleic acids | separation permanent magnets (e.g., neodymium |
| and | magnets) are used, which collect /“bind” the |
| magnetic | beads at defined spots on the inner cavity walls. |
| particles. | The magnets are installed outside but within |
| | close proximity to the separate vessels. The |
| | permanent magnets can be moved / transferred |
| | along the reaction cavities in order to perform |
| | the following requirements: |
| | 1. Collect a maximum amount of beads |
| | (within a fluid) independent of the |
| | filling volume / height. |
| | 2. Manipulate the magnetic beads and |
| | locate the pellets at defined spots inside |
| | the cavities. |
| | 3. Move / lower the magnets to decrease |
| | the magnetic flux density inside the |
| | vessel to release the magnetic beads for |
| | resuspension. |
| | Magnetic separation and parallel liquid |
| | aspiration are required for DiTi-based liquid |
| | handling steps only. |
| Liquid waste | Discarding of already used / processed liquid |
| discarding | components consists of two individual steps: |
| | 1. Magnetic separation of beads, aspiration |
| | of supernatant and transfer of liquids to |
| | tip stand cavity, which serves as |
| | intermediate waste storage. |
| | 2. Aspiration of liquid inside the tip stand |
| | during downward movement of lift |
| | whereas the aspiration probe is located |
| | above the according cavity. |
| DiTi placing | Transport sledge drives tip stand cavity of the |
| (by wash lift) | extraction consumable below DiTi, which is |
| | installed on the wash lift. Lift performs |
| | downwards movement for tip placing. An |
| | automated strip off / peel off mechanism enables |
| | the release of the tip. |
| DiTi pick up | At the consumable insertion / removal position |
| (by pipettor) | the pipettor is able to pick up tips from the |
| | consumable or the transport sledge. A vertical |
| | downwards movement allows the coupling of |
| | robot and disposable. The individual tip pick up / |
| | discarding is mandatory if the assay involves a |
| | DiTi exchange (e.g., increase extraction purity). |
| Extraction | Transport sledge with equipped extraction |
| consumable | consumable moves to insertion / removal |
| removal | location. Handling robot couples to integrated |
| | interface via vertical downwards movement. |
| | Afterwards the robot is able to remove the |
| | consumable from the transport sledge. |

The advantages of the invention can be summarized as follows:
a. General processing flexibility regarding liquid components (reagents, magnetic beads and samples) and extraction assay parameters (e.g., processing orders, volumes, temperatures, repetition numbers, durations etc.) including the simultaneous performance of different extraction assays/protocols; adaption/alignment of instrument performance to assay needs.
b. Instrument architecture, design and method allows flexibility regarding disposable tip consumption (e.g., multi-pipetting mode, possible tip exchange during extraction etc.).
c. An empty (not pre-filled) extraction consumable provides diverse advantages:
   iv. Low-cost consumable (e.g.no filling and sealing required, reduced effort for shelf-life testing, low effort for storage and labeling etc.).
   v. High flexibility regarding reagents, volumes etc.
   vi. No additional handling steps (e.g., piercing off oils).
d. Low disposable tip consumption due to dispense/injection of (insensitive) bulk fluids.
e. Design (of consumable and device) allows wash lift with simultaneous handling of disposable tip(s) and aspiration probe(s), which reduces the hardware effort.
f. Consumable design to avoid/reduce the risk of contamination:
   vii. Handling interface not aligned with reaction cavities.
   viii. Drip chambers between reaction cavities to collect dropped and spilled liquids.
   ix. Cavity arrangement ensures that the contaminated aspiration probe(s) enters only already used/processed cavities.
   x. Suitable cavity volumes and shapes in order to avoid spilling and splashing of volumes during liquid handling procedures (e.g., tip mixing).
g. Multiple and independent main processing modules to ensure a redundant system architecture/design; system can configured/upgraded that all process stations/elements are redundant.
h. Scalable and modular design of the extraction module.
i. Instrument separation (Extraction and PCR Side) and eluate shuttle to avoid/reduce the risk of contamination.
j. Direct and flexible handling of consumables via gripper (pick up and place actions).
k. “Tip mixing”: Mixing and resuspension of components via tip and repeated aspiration and dispense. Reliable liquid handling independent from properties and characteristics of the component (e.g., magnetic bead size and weight).

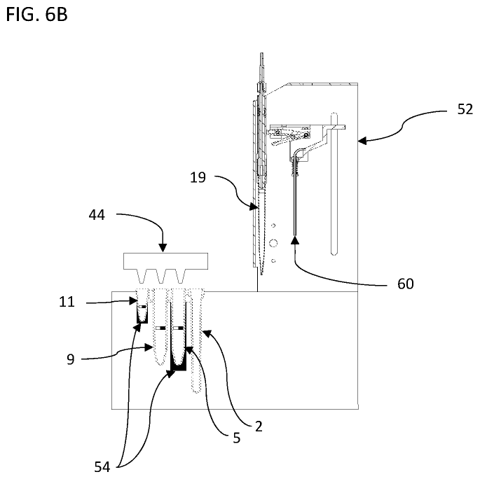

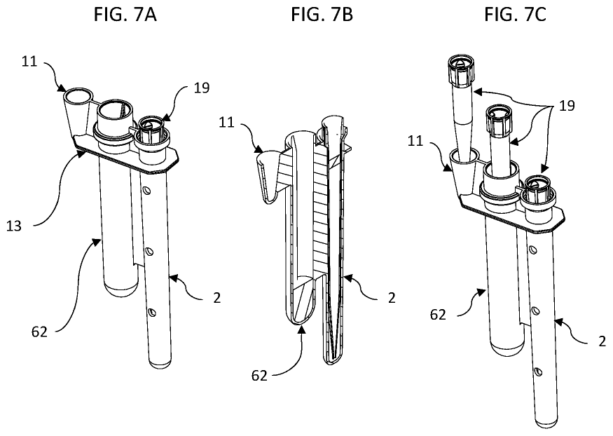

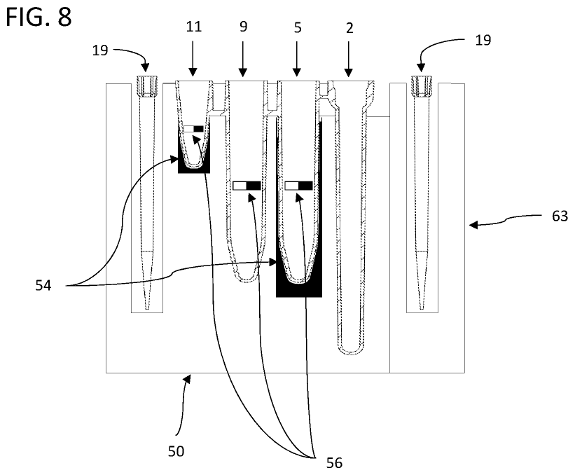

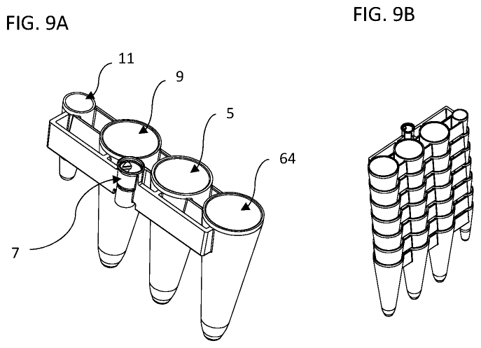

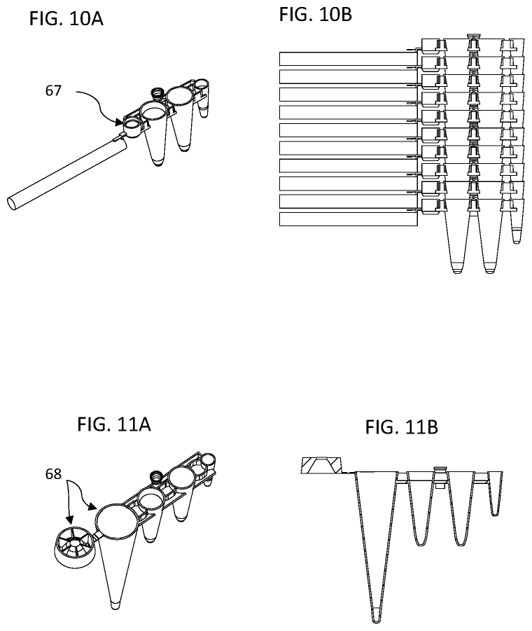

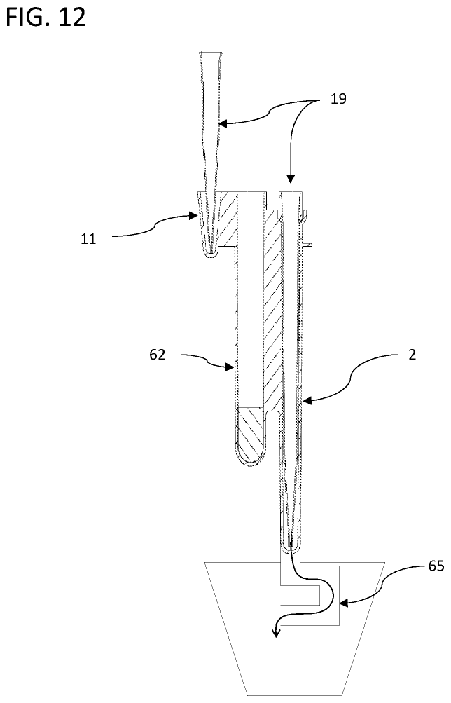

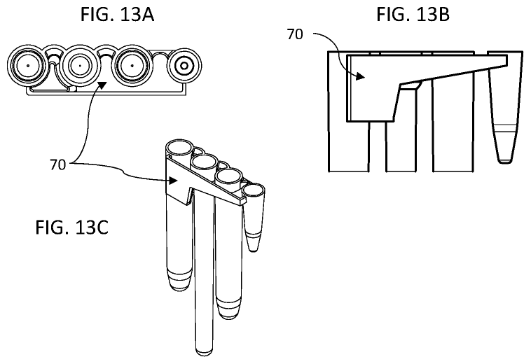

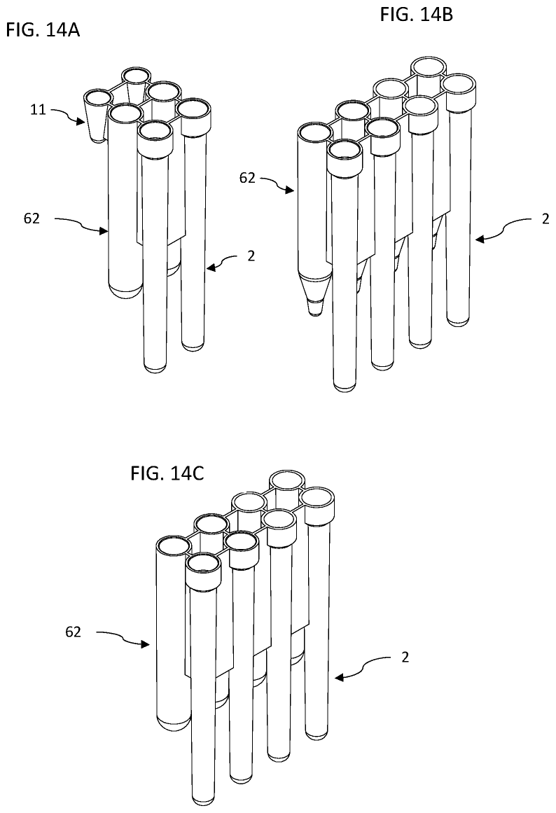

Alternative approaches may encompass:
l. Extraction consumable with one reaction and one tip stand cavity.
m. Extraction consumable with a reaction cavity 62, an elution cavity 11 and a disposable tip stand and intermediate waste cavity 2 (see FIG. 7)
n. Extraction consumable with multiple reaction (different to above-described invention) and one tip stand cavity.
o. Extraction consumable with one or multiple reaction cavities and also multiple tip stand cavities.
p. Extraction consumable delivered/pre-equipped with disposable tip.
q. Tip stand cavities, which are integrated part of the transport sledge.
r. Multiple tip stands cavities in transport sledge to differentiate between used and unused tips to avoid cross-contamination.
s. Detachable tip stand cavities 63 in transport sledge 50 (see FIG. 8), which allow cavity cleaning/decontamination (servicing of potential contaminated parts).
t. Stackable consumable designs:
   xi. Stackable extraction consumable without tip stand (see FIG. 9).
   xii. Consumable design requires different loading and supply concept. (“Flying tip stand 67”: Device/mechanism is required for DiTi handover between pipettor and wash lift when an extraction consumable without tip stand is used.)
   xiii. Stackable extraction consumable with “flexible” tip stand 68. Separated tip stand geometries to allow/ensure stackability of variants. Flexible attached geometries need to be aligned/orientated during supply and/or preparation process.
u. Liquid waste discarding options based on waste channel 65 (or funnel, drip pan etc.), which is part of the extraction module or instrument (see FIG. 12).
   xiv. Pipetting into liquid waste channel 65 via wash lift 52 or pipettor 17.
   xv. Tip stand with integrated drain feature for discarding in waste channel 65 via dispense/“blow out”. Drain should avoid cross-contamination of the tip.
v. Dispense and intermediate storage of liquid waste in common drip pan cavity 70, which surrounds the reaction cavities (FIG. 13).
w. Extraction module based on a track approach instead of discrete positions.
x. Discarding of used tips during or after extraction via direct eject of tips in solid waste or waste chute below the isolation bays.
y. Separated lift drives for independent actuation DiTi device(s) and aspiration probe(s).
z. Multiple pipettors or pipetting cassettes instead of wash lifts.
aa. Pipetting of bulk fluids instead of dispense/injection.
bb. Transfer of consumable via distributor subsystem (and e.g., push/pull interactions) instead of gripper;
cc. Using a number of cavities suitable for the respective assay, e.g., six cavities for high throughput as shown in FIG. 14.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMERALS

1 consumable
2 disposable tip stand and intermediate waste cavity
5 lysis cavity
7 tube handling interface
8 interface of handling device
9 wash cavity
11 elution cavity
13 bridge feature
15 drip and spill protection
17 pipettor
19 Disposable filter tip
30 PCR side
32 extraction side
34 extraction part
36 liquid/solid waste
38 bulk fluid supply
40 instrumentation separation
44 dispense sledge
45 disposable tip loading module
46 eluate shuttle
47 sample loading module
49 extraction consumable and reagent loading module
50 consumable sledge
52 wash lift
54 cavity heating
56 separation magnets
60 aspiration probe
62 reaction cavity
63 detachable tip stand cavity
64 waste cavity
65 waste channel
67 Flying tip stand
68 Flexible tip stand
70 common drip pan

What is claimed is:

1. A consumable for handling liquids in automated analyser systems, comprising:
a plurality of cavities which are connected by a bridge, wherein the bridge defines a horizontal axis which connects the plurality of cavities, which are arranged in a straight line and wherein at least one cavity of the plurality of cavities is shaped to accommodate a pipette tip; and
a handling interface, which is attached to the bridge.

2. The consumable of claim 1, wherein the bridge has a concave shape between two neighbouring cavities of the plurality of cavities to collect spilled liquids.

3. The consumable of claim 1, wherein the bridge is arranged next to the openings of the plurality of cavities.

4. The consumable of claim 1, wherein each of the plurality of cavities has a different diameter and/or depth and/or shape.

5. A device for processing samples in an automated analyser system, comprising:
a loading section for
i. consumables according to claim 1;
ii. liquids necessary for sample processing; and
iii. pipette tips adjusted to at least one cavity of the consumable's plurality of cavities for storing pipette tips;
a handling device for moving the consumables by interacting with the handling interface of the consumable; and
a dispense robot for injecting liquids stored in the device into respective cavities of the plurality of cavities of the consumable; and
a control unit for storing information and protocols for different processing assays wherein the control unit is connected to a drive of the handling device and a drive of the dispense robot.

6. The device of claim 5, comprising further sections for different processing steps which are each stored in the control unit for performing them.

7. The device of claim 5, wherein a further section is configured to accommodate a plurality of consumables which can be processed simultaneously.

8. The device of claim 5, further comprising means for transporting the consumables between different sections.

9. The device of claim 7, wherein the means for transporting of the consumable are a sledge with a corresponding drive system.

10. The device of claim 9, wherein the sledge comprises cavities for heating and/or cooling of liquids in a cavity of the plurality of cavities in a consumable and/or magnets for separating magnetic beads comprised in a liquid in a cavity of the plurality of cavities in a consumable.

11. The device of claim 5, comprising a section for nucleic acid isolation and/or for performing Polymerase Chain Reactions.

12. The device of claim 5, wherein the dispense robot comprises a plurality of dispense units.

13. A method for extraction of a target compound from a liquid, comprising the steps of:
placing a consumable with a handling device through interaction with the handling interface of the consumable according to claim 1 into a transport sledge;
moving the consumables in the transport sledge to a dispense position;
sequential injection of bulk fluids into reaction vessels of the consumable according to a pre-defined injection protocol;
sequential addition of reagents and a sample into pre-defined vessels of the consumable;
applying a pipette tip into the storage cavity of the consumable;
moving the consumable below a wash lift for picking up pipette tip
heating liquids in lysis and elution cavities of the consumable at pre-defined temperatures according to a pre-selected protocol;
aspirating and dispensing heated liquids for mixing them;
aspirating liquid and dispensing it into a target cavity of the consumable, adding magnetic beads;
magnetic bead separation by moving a separation magnet to the outer wall of the target cavity;
aspirating supernatant with an aspiration probe;
moving the consumable with the transport sledge to the below the wash lift;
pipetting dispensing and aspirating wash buffer into the target cavity for washing the fixed magnet beads which are released after dispensing wash buffer and fixed prior to aspirating wash buffer by moving the separation magnet from and to the outer wall of the target cavity; and
adding an elution buffer to the target cavity and collecting the supernatant comprising the target compound.

14. The method of claim 13, wherein the target compound is a nucleic acid, peptide or protein.

15. The method of claim 13, comprising the separation magnets are being moved along the outer wall of the target cavity.

16. The method of claim 13, wherein the predefined protocol comprises the step of cooling of the liquids.

17. A method for the amplification of nucleic acids, comprising the steps of:
extracting nucleic acids from samples in a consumable in a first section of a device comprising sections for different processing steps; and
performing Polymerase Chain Reactions in a second section of said device.
